(19) United States
(12) Patent Application Publication
(10) Pub. No.: US 2025/0388492 A1
(43) Pub. Date: Dec. 25, 2025

(54) USE OF SUPERCRITICAL CARBON DIOXIDE FOR SORBENT EXTRACTION

(71) Applicant: Evoqua Water Technologies LLC, Pittsburgh, PA (US)

(72) Inventors: Simon P. Dukes, Chelmsford, MA (US); Gary C. Ganzi, Lexington, MA (US); Thomas K. Mallmann, Rockford, IL (US); Joshua Griffis, Ashburnham, MA (US); Mohsen Ghafari, Lowell, MA (US)

(21) Appl. No.: 18/880,982

(22) PCT Filed: Feb. 14, 2023
(86) PCT No.: PCT/US2023/013052

§ 371 Date: Jan. 3, 2025

Related U.S. Application Data
(60) Provisional application No. 63/358,249, filed on Jul. 5, 2022.

(51) Int. Cl. C02F 1/42; C02F 1/26; C02F 101/36

(52) U.S. Cl. CPC C02F 1/42; C02F 1/26; C02F 2001/425; C02F 2101/36; C02F 2301/066; C02F 2303/16

(57) ABSTRACT

Systems and methods for treating water containing PFAS are disclosed. Adsorption media may be used to remove PFAS from water. Supercritical carbon dioxide (sCO₂) may be used to release PFAS from loaded adsorption media to form an extractant mixture. The PFAS may then be separated from the extractant mixture for downstream storage or destruction.

### CROSS-REFERENCE TO RELATED APPLICATION

This application claims priority to U.S. Provisional Patent Application Ser. No. 63/358,249, filed on Jul. 5, 2022 and titled “USE OF SUPERCRITICAL CARBON DIOXIDE FOR SORBENT EXTRACTION,” the entire disclosure of which is hereby incorporated herein by reference in its entirety for all purposes.

### FIELD OF TECHNOLOGY

Aspects and embodiments disclosed herein are generally related to the removal and elimination of per-and polyfluoroalkyl substances (PFAS) from water.

### BACKGROUND

There is rising concern about the presence of various contaminants in municipal wastewater, surface water, drinking water and groundwater. For example, perchlorate ions in water are of concern, as well as PFAS and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial household and workplace products, municipal water, agricultural soil and irrigation water, and even drinking water. PFAS molecules have been shown to cause adverse health effects in humans and animals.

The U.S. Environmental Protection Agency (EPA) has issued a Contaminant Candidate List (CCL 5) which includes PFAS as a broad class inclusive of any PFAS that fits the revised CCL 5 structural definition of per-and polyfluoroalkyl substances (PFAS), namely chemicals that contain at least one of the following three structures:
R—(CF2)—CF(R′)R″, where both the CF2 and CF moieties are saturated carbons, and none of the R groups can be hydrogen.
R—CF2OCF2—R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of treating water containing a per- or poly-fluoroalkyl substance (PFAS) is disclosed. The method may involve introducing water containing PFAS to adsorption media to promote loading of the adsorption media with PFAS, introducing supercritical carbon dioxide (sCO₂) to adsorption media loaded with PFAS to extract PFAS from the loaded adsorption media thereby forming an extractant mixture containing PFAS and treated adsorption media depleted of PFAS, separating the extractant mixture containing PFAS from the treated adsorption media depleted of PFAS, and separating PFAS from the extractant mixture for downstream storage or destruction.

The PFAS may comprise perfluorooctane sulfonic acid (PFOS), perfluorooctanoic acid (PFOA), or a perfluoroalkyl ether carboxylic acid.

In some aspects, the adsorption media may comprise granulated activated carbon (GAC) or ion exchange resin. The method may further comprise performing multiple extractions on a single batch of loaded adsorption media.

In some aspects, liquid or gas carbon dioxide (CO₂) may be introduced to the adsorption media loaded with PFAS. The method may further comprise promoting conversion of the CO₂ to the sCO₂. Promoting conversion of the liquid or gas CO₂ to the sCO₂ may comprise adjusting pressure and/or temperature conditions.

In some aspects, separating the extractant mixture containing PFAS from the treated adsorption media may comprise depressurizing the extractant mixture to promote flow of sCO₂ containing PFAS away from the treated adsorption media. Separating PFAS from the extractant mixture may comprise separating PFAS from gaseous CO₂. The method may further comprise reusing the gaseous CO₂ or storing the gaseous CO₂ for reuse.

In some aspects, the method may further comprise destroying the separated PFAS. In some non-limiting aspects, PFAS may be destroyed via supercritical water oxidation (SCWO) treatment. The PFAS may generally be destroyed via incineration, plasma, electrooxidation or UV reduction treatment.

In some aspects, at least a portion of the loaded adsorption media or the treated adsorption media may be destroyed. The destroyed adsorption media may originate from about 5% to about 20% of an upper level of an associated adsorption column. The PFAS and/or adsorption media may be destroyed onsite relative to the extraction step.

In some aspects, the method may further comprise reactivating or regenerating the treated adsorption media. The reactivated or regenerated adsorption media may be reused for water treatment. In non-limiting aspects, new adsorption media may be added to a bottom of an adsorption column and the reactivated or regenerated adsorption media may be used to fill a remainder of the adsorption column. In some specific non-limiting aspects, about 10% of the adsorption column may be filled with new adsorption media and the balance may be filled with the reactivated or regenerated adsorption media. In some aspects, no adsorption media is used for polishing downstream of the adsorption column.

In some aspects, the method may further comprise reusing the treated adsorption media without any further processing.

In some aspects, the method may further comprise optimizing the supercritical conditions for the sCO₂ with respect to PFAS extractability. A polarity of the extractant mixture may be adjusted.

In some aspects, the sCO₂ may be mixed with an additional solvent. The additional solvent may be selected from the group consisting of: water, alcohol, methanol, ethanol, acetonitrile, carbon disulfide and ammonium hydroxide. The additional solvent may comprise ammonia or an alkylamine. The additional solvent may comprise water carried over with the adsorption media used for treating the water containing PFAS.

In some aspects, any additional solvent may be separated from the extractant mixture. The method may further comprise disposing of or destroying the separated additional solvent along with the PFAS. The method may further comprise purifying and reusing the separated solvent for extraction.

In some aspects, the method may further comprise promoting electroneutrality when the adsorption media comprises ion exchange resin. For example, an acid, a base or a salt may be added to the sCO₂.

In some aspects, the method may further comprise introducing a cationically charged organic compound or a cationic compound of high solubility to the sCO₂. For example, a tetraalkylammonium salt or hydroxide may be added to the sCO₂.

In some aspects, the method may further comprise introducing at least one coordinating compound into the sCO₂. In other aspects, the method may further comprise introducing a source of anion to the sCO₂.

In some aspects, the method may further comprise extracting other organic contaminants from the loaded adsorption media along with PFAS.

In some aspects, the method may be associated with a PFAS removal rate of at least about 99%.

In accordance with one or more aspects, a system for treating water containing per- or polyfluoroalkyl substances (PFAS) is disclosed. The system may comprise a contact reactor containing adsorption media. The system may further comprise an extractor configured to receive adsorption media loaded with PFAS from the contact reactor and having an inlet fluidly connectable to a source of CO₂, the extractor configured to promote conversion of the CO₂ to supercritical CO₂ (sCO₂) under predetermined conditions. The system may still further comprise a separator fluidly connected to an outlet of the extractor, the separator having a waste outlet and a gaseous CO₂ outlet.

In some aspects, the system may further comprise a heater in thermal communication with the extractor.

In some aspects, the system may further comprise a source of an additional solvent in fluid communication with the extractor.

In some aspects, the system may further comprise a storage tank fluidly connected to the gaseous CO₂ outlet. In other aspects, the source of the CO₂ may be associated with the gaseous CO₂ outlet of the separator.

In some aspects, the adsorption media may comprise granular activated carbon (GAC) or ion exchange resin. In some non-limiting aspects, the contact reactor is at least partially filled with treated adsorption media from the extractor. In at least some non-limiting aspects, no secondary contact reactor is positioned downstream of the separator.

In some aspects, the system may further comprise a PFAS destruction unit downstream of the waste outlet of the separator.

In some aspects, the system may further comprise a reactivation or regeneration unit downstream of the extractor.

In some aspects, the system may further comprise a polishing unit operation positioned downstream of the separator.

In some aspects, the system may be associated with a PFAS removal rate of at least about 99%.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in the various figures is represented by a like numeral. For purposes of clarity, not every component may be labeled in every drawing. In the drawings:

FIG. 1 presents a phase change diagram associated with carbon dioxide (CO₂) in accordance with one or more embodiments; and

FIG. 2 presents a process flow diagram associated with systems and methods for using supercritical carbon dioxide (sCO₂) to extract per-or poly-fluoroalkyl substances (PFAS) from adsorption media in accordance with one or more embodiments.

### DETAILED DESCRIPTION

In accordance with one or more embodiments, water containing a per- or poly-fluoroalkyl substance (PFAS) may be treated. Adsorption media may be loaded with PFAS and then supercritical carbon dioxide (sCO₂) may be introduced to produce an extractant mixture containing PFAS and treated adsorption media depleted of PFAS. PFAS can be separated from the extractant mixture for storage or destruction. The adsorption media may be reused. Beneficially, PFAS treatment may be performed in an efficient and effective manner as described further herein.

PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties. Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

It may be desirable to have flexibility in terms of what type of approach is used for treating water containing PFAS. For example, the source and/or constituents of the process water to be treated may be a relevant factor. The properties of PFAS compounds may vary widely. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. Market conditions may also be a controlling factor. These factors may be variable and therefore a preferred water treatment approach may change over time.

Use of various adsorption media is one technique for treating water containing PFAS. Activated carbon and ion exchange resin are both examples of adsorption media that may be used to capture PFAS from water to be treated. Other adsorption media may also be implemented. Such techniques may be used alone or in conjunction.

Conventional activated carbon adsorption systems and methods to remove PFAS from water have shown to be effective on the longer alkyl chain PFAS but have reduced bed lives when treating shorter alkyl chain compounds. Activated carbon treated with a surfactant can have increased bed life. Some conventional anion selective exchange resins have shown to be effective on the longer alkyl chain PFAS but have reduced bed lives when treating shorter alkyl chain compounds.

Membrane processes such as nanofiltration and reverse osmosis have been used for PFAS removal. Normal oxidative processes have heretofore been unsuccessful in oxidizing PFAS. Even ozone has been reported to be an ineffective oxidant. There have been reports of PFAS moieties being destroyed by combined oxidative technologies such as ozone plus UV or use of specialized anodes to selectively oxidize PFAS. Such techniques may be used in conjunction with the various embodiments disclosed herein.

In accordance with one or more embodiments, there is provided systems and methods of treating water containing PFAS. The water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background total organic carbon (TOC) is 50 ppm, a conventional PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC prior to treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In accordance with one or more embodiments, adsorption media is used to remove PFAS from water. In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC).

In accordance with one or more embodiments, GAC may refer to a porous adsorbent particulate material, produced by heating organic matter, such as coal, wood, coconut shell, lignin or synthetic hydrocarbons, in the absence of air, characterized that the generally the granules or characteristic size of the particles are retained by a screen of 50 mesh (50 screen openings per inch in each orthogonal direction).

Without wishing to be bound by any particular theory, PAC typically has a larger surface area for adsorption that GAC and can be agitated and flowed more easily, increasing its effective use.

In some embodiments, the GAC used for adsorption removal of PFAS may be modified to enhance its ability to remove negatively charged species from water, such as deprotonated PFAS. For example, the GAC may be coated in a positively charged surfactant that preferentially interacts with the negatively charged PFAS in solution. The positively charged surfactant maybe a quaternary ammonium-based surfactant, such as cetyltrimethylammonium chloride (CTAC). Various activated carbon media for water treatment are known to those of ordinary skill in the art. In at least some non-limiting embodiments, the media may be an activated carbon as described in U.S. Pat. No. 8,932,984 and/or U.S. Pat. No. 9,914,110, both to Evoqua Water Technologies LLC, the entire disclosure of each of which is hereby incorporated herein by reference in its entirety for all purposes.

In some embodiments, separation of PFAS from a source of contaminated water may be achieved using an adsorption process, where the PFAS are physically captured in the pores of a porous material (i.e., physisorption) or have favorable chemical interactions with functionalities on a filtration medium (i.e., chemisorption). In accordance with one or more embodiments, a PFAS separation stage may include adsorption onto an electrochemically active substrate. An example of an electrochemically active substrate that can be used to adsorb PFAS is granular activated carbon (GAC). Adsorption onto GAC, compared to other PFAS separation methods, is a low-cost solution to remove PFAS from water that can potentially avoid known issues with other removal methods, such as the generation of large quantities of hazardous regeneration solutions of ion exchange vessels and the lower recovery rate and higher energy consumption of membrane-based separation methods such as nanofiltration and reverse osmosis (RO).

The removal material as described herein is not limited to particulate media, e.g., activated carbons, or cyclodextrins. Any suitable removal material, e.g., adsorption media, may be used to adsorb or otherwise bind with pollutants and contaminants present in the waste stream, e.g., PFAS. For example, suitable removal material may include, but are not limited to, alumina, e.g., activated alumina, aluminosilicates and their metal-coordinated forms, e.g., zeolites, silica, perlite, diatomaceous earth, surfactants, ion exchange resins, and other organic and inorganic materials capable of interacting with and subsequently removing contaminants and pollutants from the waste stream.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, may become loaded with PFAS. Treated water, i.e., water containing a lower concentration of PFAS than the source water may be separated from the removal material, e.g., adsorption media. The contact reactor may then be placed into a cleaning mode as discussed herein for further processing of the loaded adsorption media. In accordance with one or more embodiments, loaded adsorption media, e.g. granular activated carbon (GAC) or ion exchange resin, may be further processed as disclosed further herein.

In some embodiments, the dosage of adsorption media may be adjusted based on at least one quality parameter of the water to be treated. For example, the at least one quality parameter may include a target concentration of the PFAS in the treated water to be at or below a specified regulatory threshold.

In accordance with one or more embodiments, a water treatment system may include a source of water connectable by conduit to an inlet of an upstream separation system that can produce a treated water and a stream enriched in PFAS. This upstream separation system may thus concentrate the water to be treated with respect to its PFAS content. A first separation system can be any suitable separation system that can produce a stream enriched in PFAS or other compounds. For example, the upstream separation system can be a membrane concentrator with an optional dynamic membrane, reverse osmosis (RO) system, a nanofiltration (NF) system, an ultrafiltration system (UF), or electrochemical separations methods, e.g., electrodialysis, electrodeionization, etc. In such implementations, the reject, retentate or concentrate streams from these types of separation systems will include water enriched in PFAS. For example, the concentration increase of PFAS in the water upon concentrating may be at least 20× relative to the initial concentration of PFAS before concentration, e.g., at least 20×, at least 25×, at least 30×, at least 35×, at least 40×, at least 45×, at least 50×, at least 55×, at least 60×, at least 65×, at least 70×, at least 75×, at least 80×, at least 85×, at least 90×, at least 95×, or at least 100×. In some embodiments of the system, water from the source of water, or another source of PFAS containing water, can be directed into the contact reactor via conduit without the need for upstream separation to produce a stream of water enriched in PFAS. In other embodiments, water from an upstream concentration process may be directed to the contact reactor.

In some embodiments, a stream containing PFAS may be concentrated prior to processing. In other embodiments, it may be processed directly. A foam fractionation process or other approach may be used to concentrate. By example, removing ppt levels of PFAS onto GAC may concentrate the PFAS onto the media by several orders of magnitude. An eluted waste stream can then be concentrated further such as via foam fractionation by several additional orders of magnitude, with PFAS concentrations increasing by example from ppt levels up to ppb or even ppm levels to enable further treatment or destruction.

In accordance with one or more embodiments, foam fractionation may be used for concentration of the source water upstream of the adsorption media. In foam fractionation, foam produced in water generally rises and removes hydrophobic molecules from the water. Foam fractionation has typically been utilized in aquatic settings, such as aquariums, to remove dissolved proteins from the water. During foam fractionation, gas bubbles rise through a vessel of contaminated water, forming a foam that has a large surface area air-water interface with a high electrical charge. The charged groups on PFAS molecules adsorb to the bubbles of the foam and form a surface layer enriched in PFAS that can subsequently be removed. The bubbles may be formed using any suitable gas, such as compressed air or nitrogen. In some embodiments, the bubbles are formed from an oxidizing gas, such as ozone to aid in preventing competing compounds such as metals or other organics from affecting PFAS removal, which competing compounds are likely to be in much larger concentrations than PFAS. Foam fractionation systems useful for the invention are known in the art. Multiple stages may be incorporated into a foam fractionation process. Each stage will further concentrate the PFAS compounds which also results in a smaller volume of liquid. It is possible to reduce the volume by more than 99% and increase the concentration by over 200 times using foam fractionation processes. PCT publication WO2019111238 is hereby incorporated herein by reference in its entirety for all purposes.

The treated water produced by the system downstream of the contact reactor may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In accordance with one or more embodiments, supercritical carbon dioxide (sCO₂) may be introduced to PFAS-loaded removal material, e.g., adsorption media such as GAC or ion exchange resin, to produce an extractant mixture containing PFAS. A contact reactor may be placed in a cleaning mode once the adsorption media becomes loaded. Breakthrough may be one indication of excess loading. The cleaning may otherwise be performed for maintenance periodically.

During the cleaning mode, at least a portion of the adsorption media loaded with PFAS may be removed from the contact reactor and placed in an extractor. In some embodiments, the entire contact reactor may be emptied while in other embodiments only a fraction thereof may be placed in the extractor.

In accordance with one or more embodiments, sCO₂ may be introduced to the loaded adsorption media within the extractor. In some embodiments, sCO₂ may be directly introduced to the extractor. In other embodiments, liquid or gaseous CO₂ may be introduced to the extractor and conversion of the liquid or gaseous CO₂ to sCO₂ may be promoted. For example, temperature and/or pressure parameters within the extractor may be adjusted to promote formation of sCO₂ therein. The sCO2 may extract PFAS from the loaded adsorption media thereby forming an extractant mixture containing PFAS and treated adsorption media depleted of PFAS.

In some embodiments, CO₂ below supercritical levels, e.g. liquid CO₂ just below supercritical levels may be used for PFAS extraction.

In accordance with one or more embodiments, the extractant mixture can then be separated from the treated adsorption media depleted of PFAS. For example, the extractor can be depressurized to promote flow of sCO₂ containing PFAS away from the treated adsorption media to a separator. PFAS can then be separated from the extractant mixture. For example, PFAS may be separated from gaseous CO₂ in the separator. The gaseous CO₂ can be reused directly or stored for reuse.

In accordance with one or more embodiments, the separated PFAS may be destroyed. In some non-limiting aspects, PFAS may be destroyed via supercritical water oxidation (SCWO) treatment. The PFAS may generally be destroyed via incineration, plasma, electrooxidation or UV reduction treatment.

In some non-limiting embodiments, at least a portion of the loaded adsorption media or the treated adsorption media may be destroyed. The destroyed adsorption media may originate from about 5% to about 20% of an upper level of an associated adsorption column. The PFAS and/or adsorption media may be destroyed onsite relative to the extraction step.

The treated adsorption media may be reused without any further processing.

In accordance with one or more embodiments, the treated adsorption media may be reactivated or regenerated as described herein. The reactivated or regenerated adsorption media may be reused for water treatment. In non-limiting aspects, new adsorption media may be added to a bottom of an adsorption column and the reactivated or regenerated adsorption media may be used to fill a remainder of the adsorption column. In some specific non-limiting aspects, about 10% of the adsorption column may be filled with new adsorption media and the balance may be filled with the reactivated or regenerated adsorption media. In some aspects, no adsorption media is used for polishing downstream of the adsorption column.

In accordance with one or more embodiments, less than complete extraction may be performed and the extracted sorbent may be returned back to the treatment of the incoming water. At least some of the sorbent may need to be replaced with new sorbent to the extent there is any leakage of PFAS in the kinetic zone of the contact reactor bed. Any fraction of sorbent not returned to the process can also act as a fuel for a downstream PFAS destruction step, e.g. SCSWO. The new sorbent added to the bottom of the main removal tank may be sufficient to eliminate a second polisher tank of sorbent.

This concept provides a very cost effective and efficient way to treat using an adsorbent such as GAC and/or IE resin and destroy emerging contaminants with complete removal, potentially on-site (and thus no transportation or second site risk required for treating contaminated adsorbent), with no extra tankage (although it will also work with an extra tank if desired). It is cost optimized and effective because at each step there is not a need to remove all the adsorbed contaminant either in the adsorbent regeneration or the destruction phases of the process. Almost any fraction of removal or destruction will work in this process, which provides a great deal of latitude in choosing safe regeneration and destruction processes, even if they do not remove or destroy all the contaminated components.

In accordance with one or more embodiments, the supercritical conditions for the sCO₂ with respect to PFAS extractability may be optimized. In at least some embodiments, conditions may be modified to address the presence of sulfonated hydrocarbons. In at least some embodiments, solubility may generally be promoted, for example, in embodiments where the solubility of sodium or other compound is limiting. Various adjustments may be made before or during extraction. For example, a polarity of the extractant mixture may be adjusted. In some embodiments, the sCO₂ may be mixed with an additional solvent. The additional solvent may be selected from the group consisting of: water, alcohol, methanol, ethanol, acetonitrile, carbon disulfide and ammonium hydroxide. The additional solvent may comprise ammonia or an alkylamine. The additional solvent may comprise water carried over with the adsorption media used for treating the water containing PFAS.

In some embodiments, a cationically charged organic compound or a cationic compound of high solubility to the sCO₂ may be introduced. For example, a tetraalkylammonium salt or hydroxide may be added to the sCO₂.

PFAS are strong acids and present as anions at neutral pH. It follows that PFAS will be extracted as salts under most circumstances. To dissolve, both the cation and anion need to go into solution. It is not possible to dissolve or extract the anions and leave the cations behind. Supercritical fluids are poor solvents for salts. It is believed the long perfluoroalkyl tail of PFAS would enable higher solubility. That solubility alone may not be enough to dissolve PFAS salts since there needs to be a soluble cation. It is thought that ammonia or alkylamines would be more soluble in supercritical fluids than sodium or calcium. These amines could be incorporated into the supercritical fluid or added to the media prior to supercritical fluid extraction. A minimum of 1 mole amine per mole of PFAS may be needed. Mostly likely, much more amine than PFAS would be needed to facilitate dissolution of the PFAS.

Any additional solvent may be separated from the extractant mixture. The separated additional solvent may be destroyed or disposed of along with the PFAS. Alternatively, the separated solvent may be purified and reused for extraction.

In accordance with one or more embodiments, electroneutrality when the adsorption media comprises ion exchange resin may be promoted. For example, an acid, a base or a salt may be added to the sCO₂. Without cations present in the resin, PFAS cannot be removed without creating a positive charge on the resin and a negative charge in the supercritical fluid. Thus, one option is to introduce an acid or a salt in the supercritical fluid to perform the typical IX regeneration. In some embodiments, an acid may be introduced into the resin prior to extraction. For example, HCl on the resin may enable extraction of the PFAS as an acid while maintaining electroneutrality.

In accordance with one or more embodiments, a source of anion may be introduced to the sCO₂. Anion exchange resins have fixed positive charges from quaternary amines covalently bound to the polymer backbone of the resin. Anions in solution diffuse into the bead while those already in the resin bead diffuse out. It is not possible to extract PFAS from anion exchange resin unless another anion is present to replace it. A minimum of 1 equivalent of anion is needed to replace 1 equivalent of PFAS. Higher anion concentrations are preferred to drive the removal of PFAS. These anions can be incorporated into the supercritical fluid, added to the media before extraction, or generated in situ, e.g. dissolution of carbon dioxide into water.

In accordance with one or more embodiments, water may be used as a cosolvent. Water and carbon dioxide will produce carbonic acid which can dissociate in the water and generate anions to replace PFAS. Selectivity may generally be considered unfavorable as is the formation of a strong acid from weak acids. Water may also assist with carbon regeneration.

In accordance with one or more embodiments, at least one coordinating compound may be introduced into the sCO₂. Coordination chemistry can be used to extract lead into sCO₂. The solubility of cations and anionic PFAS can be facilitated with some addition of coordinating compounds, e.g. calixarenes.

In accordance with one or more embodiments, other organic contaminants from the loaded adsorption media may be extracted along with PFAS.

In accordance with embodiments of the present disclosure, the separation of PFAS and extraction of sorbents such as spent GAC, ion exchange resin, or other media is achieved using supercritical carbon dioxide (sCO₂).

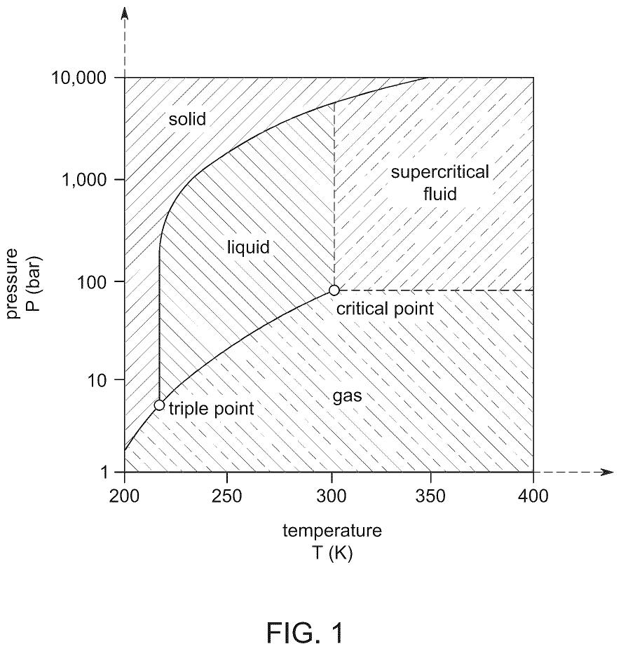

Referring to FIG. 1, carbon dioxide (CO₂) is a gas at standard temperature and pressure (“STP”). When CO₂ is cooled to −57° C., it becomes a liquid. If cooled further, to −78° C., CO₂ becomes solid, forming what is known as “dry ice”. There are certain conditions of temperature and pressure, called “supercritical” conditions, at which CO₂ can behave both as a gas and liquid, thereby forming a supercritical fluid. The critical pressure for CO₂ is 72.8 atm (or 1070 psi), while the critical temperature is 31° C. When temperature and pressure change back to STP, CO₂ again becomes a gas.

Under different conditions, these properties of CO₂ can be used to purify materials in a green and economical way by using sCO₂ as an extractant. CO₂ is generally considered to be non-polar solvent, mostly due to its low dielectric constant and zero molecular dipole moment. However, under supercritical conditions, CO₂'s properties change and can have polar attributes that enable it to be used as a solvent for many materials. For instance, sCO₂ finds several applications in extraction processes such as, e.g., the production of decaffeinated coffee, the extraction of various natural products from various plants, etc. At the end of the process, CO₂ can be allowed to evaporate and leave behind the pure product. Alternatively, CO₂ can be collected and reused, making the process economical. This process can be done in a batch or semicontinuous way.

The use of sCO₂ is very attractive because it allows for easy isolation of the reaction or extraction product. When the system is brought to STP, the CO₂ may evaporate, leaving behind the pure product. Accordingly, sCO₂ can be used in the extraction of spent adsorbing materials used in water remediation such as granulated activated carbon (GAC), ion exchange resins (IXR), and other media. sCO₂ can penetrate the pores of the adsorbent particles and dissolve PFAS and other organic materials that are water contaminants for extraction. However, the relatively low pressures and temperatures needed for CO₂ to achieve supercritical conditions prevents destruction of the adsorbing materials themselves, while also simplifying the system components necessary for on-site extraction. In some embodiments, it is desirable to remove at least 95% of PFAS from the GAC, IXR, or other sorbent via sCO₂ extraction or a combination of sCO₂ extraction with treatment using one or more solvents, as described below.

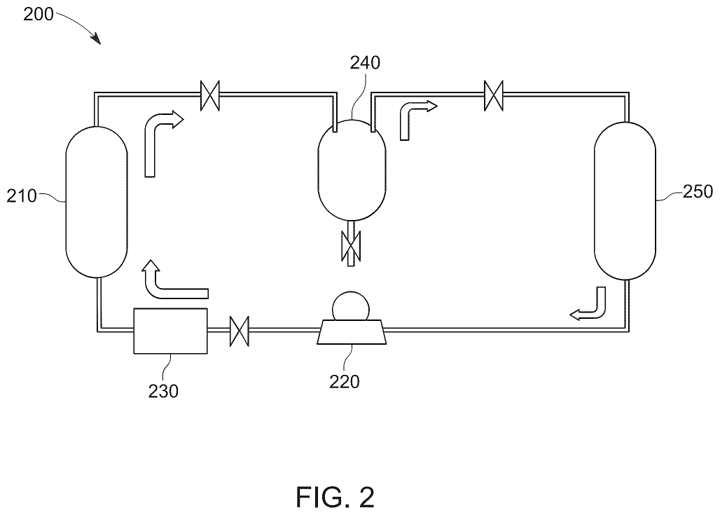

Referring to FIG. 2, a simplified diagram of a system 200 using sCO₂ extraction for removing PFAS from, e.g., GAC is shown. In some embodiments, the sorbent (e.g., GAC) can be loaded in the extractor 210. The extractor 210 is then filled with liquid CO₂, while at the same time being pressurized (via the pump 220) and heated (via the heater 230) such that the CO₂ reaches its supercritical conditions. The system is allowed to stay at a certain state for given amount of time before being depressurized, which allows CO₂ to flow to the separator 240. Under the conditions in the separator, the CO₂ again becomes a gas. The gaseous CO₂ is allowed to flow back to the CO₂ tank 250, where it is again liquified, pressurized, and heated to supercritical conditions for the next extraction.

In some embodiments, multiple extractions may be carried out on the same batch of adsorbent to improve total extraction efficiency of water contaminant materials. Alternatively, in other embodiments, the adsorbent (such as, e.g., GAC or IXR) may be replaced by a new batch for extraction, while the PFAS or other organic contaminants may be isolated in the separator and can be removed. In some embodiments, the isolated PFAS and/or other contaminants may be destroyed on-site by any appropriate method such as, e.g., supercritical water oxidation (SCWO), electrochemical treatment using Ti₄O₇ electrodes from Magneli Materials, Inc., etc. In other embodiments, the isolated PFAS or other contaminants may be removed from the site for remote destruction and/or safe storage.

It is to be understood that different supercritical conditions of temperature and pressure will have different effect on the extractability of PFAS and other organic contaminants. As such, the sCO₂ conditions for PFAS extraction from the adsorbent are to be optimized to ensure sufficient extractability. Furthermore, these optimized conditions may allow for efficient regeneration of spent GAC and/or other adsorbing media by removing the contaminants.

Beyond temperature and pressure, other parameters are also important in the extraction. For example, extractant mixture polarity is an important property in balancing the solubility of the organic contaminants in the extractant. The higher the solubility of the organic contaminants in the extractant mixture, the higher the efficiency of the extraction process. Thus, sCO₂ can be used in combination with other solvents such as, e.g., alcohols, methanol, ethanol, acetonitrile, carbon disulfide, ammonium hydroxide, etc. In some embodiments, the solvents may be separated from the extractant mixture (along with the contaminants) and properly disposed of or destroyed. In other embodiments, the solvents may be purified and reused in the sCO₂ extraction of organic contaminants from the adsorbent material(s).

In some embodiments, after the PFAS is extracted from the GAC, IXR, or other sorbent, an activation step (in the case of GAC) or a regeneration step (in the case of IXR) may be needed. In some embodiments, the activation and/or regeneration step may be performed on-site. In other embodiments, the spent GAC or IXR may be removed from the site for remote activation or regeneration.

Accordingly, the media extraction process using sCO₂ as described above is considered to be a comparatively inexpensive and environmentally friendly alternative to, e.g., high temperature treatment of spent GAC, which may release CO₂ and other gaseous byproducts to the atmosphere.

After the PFAS is eluted off the adsorption media, the adsorption media, if not adequately-regenerated through the elution process for direct reuse back into the treatment system, may be reactivated or further regenerated for reuse, or instead destroyed. For example, GAC may be reactivated using heated kilns operating at temperatures of about 875° C. to 1000° C. (or even higher). Alternatively, the GAC may be regenerated using solvents, or further regenerated using treatment with multicomponent mixtures and additives comprising supercritical carbon dioxide. Ion exchange resins can be regenerated using typical ion exchange regenerants, regenerants using amine surfactants, or regenerants comprising multicomponent mixtures and additives comprising supercritical carbon dioxide. In other embodiments, ion exchange resins can be mineralized via incineration. Examples of such processes are disclosed in U.S. Provisional Patent Application No. 63/432,614 and PCT Patent Application No. PCT/US2022/051183, all owned by Applicant which are hereby incorporated herein by reference in their entireties for all purposes.

For example, anion exchange resins are an efficient class of sorbents in removal of PFAS materials from water. They are divided into two main categories, strong base anion exchange resins, (SBAER) and weak base anion exchange resins (WBAER). Their structural differences define them clearly, as well as the ways they can be used as sorbents and the ways by which they can be regenerated. Strong base anion exchange resins, after they are used for PFAS removal from water, can only be regenerated by the use of organic solvents such as alcohols, methanol, ethanol, isopropanol. Weak base anion exchange resins, on the other hand, can be regenerated with aqueous alkali solutions, such as sodium hydroxide.

In accordance with one or more embodiments, carbon reactivation includes a method of thermally processing activated carbon, to remove adsorbed components contained within its pores without substantial damage to the original porosity of the carbon. Carbon reactivation is commonly performed by subjecting the carbon to elevated temperatures typically but not limited to temperatures of 700° C. to 800° C. in a controlled atmosphere including water vapor in a rotating kiln or multiple hearth furnace. It can be distinguished from carbon regeneration which may utilize solvents, chemicals, steam, or wet oxidation processes for removal of adsorbed components. During the reactivation process approximately 5% to 10% of the original carbon is reduced to carbon fines or is vaporized.

In accordance with one or more embodiments, there is provided a method of treating water containing PFAS. The method may include dosing water containing PFAS with adsorption media to promote loading of the adsorption media with PFAS. The method further may include producing an extraction mixture including PFAS. In some embodiments, the PFAS include one or more PFOS and PFOA. The extraction mixture containing PFAS may be processed as described herein.

In some embodiments, systems and methods disclosed herein can be designed for centralized applications, onsite application, or mobile applications via transportation to a site. The centralized configuration can be employed at a permanent processing plant such as in a permanently installed water treatment facility such as a municipal water treatment system. The onsite and mobile systems can be used in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container. Beneficially, material containing PFAS need not be transported across a relatively far distance in accordance with various embodiments. Localized removal and destruction is enabled herein.

The function and advantages of these and other embodiments can be better understood from the following example. This example is intended to be illustrative in nature and is not considered to be in any way limiting the scope of the invention.

### PROPHETIC EXAMPLE

A media regeneration process, preferably on-site, will remove about 80% to about 90% of the emerging contaminant. To permit safe return of the adsorbent for use, about 10% to about 20% of new adsorbent will be added to the bottom portion of the tank and the regenerated resin will be used at the upper portion of the tank. The top section will still capture 80% to 90% of the incoming contaminant, while the bottom new adsorbent section will polish any remaining emerging contaminant either coming off the regenerated section of the bed, or from any trace un-removed contaminant from the feed. Complete removal via adsorption followed by destruction of the concentrated emerging contaminants off the adsorbent, with no residual waste can thus be achieved in a way that can be effectively completed on-site and with a single adsorption tank. Great flexibility in the relative effectiveness of the adsorption bed, the regeneration process, and destruction processes may thus be leveraged.

Even if a regeneration or destruction process is theoretically able to remove or destroy 100% of the contaminant, it may be more economical to use the process for a lesser percent destruction to optimize the cost of the removal or destruction process. For example, a removal or destruction process requires X amount in energy or time for 90% removal and 10X the energy or time for 100% removal. The process can operate such that only 90% removal/destruction is needed.

The feed reaches the adsorbent column that, for example, contains 90% on the upper part of the column adsorbent that has been 80% regenerated with 20% of the capacity still taken up with contaminant that does not come off during the regeneration—i.e., still has 80% available capacity for contaminant removal (other % regenerations are possible). This top level, even though it has 80% capacity, still might leak a small amount of contaminant if used alone. This is solved with 10% of the column at the bottom being new adsorbent which has never seen contaminant to polish anything that makes if past the 90%.

As an example, assume the column is sized such that it exhausts every 6 months. This column will remove all the contaminant because if any contaminant leaks through the top 90%, it will be polished with the bottom 10% containing new adsorbent for complete removal. The height of the bed is not directly related to the percentage of the regenerant recycled, but instead is the length of column needed kinetically to remove the final traces of contaminant. It could be, for example, the bottom 5% or bottom 20% depending on the kinetics, independent of the percentage contaminant removed during regeneration of exhausted adsorbent. The percentage contaminant removed per regeneration simply speaks to the removal capacity of the tank and sizing of the tank to run through the cycle in a specified time period. Every time period, e.g. 6 months operation, there is nearing breakthrough of contaminant and it is time to replace the bed. A large advantage of this system is that a second polisher tank of adsorbent will not be needed, since the polishing will occur in the main bed, although aspects of this invention would be effective with a polisher tank where the main bed is completely changed out and sent to regeneration and perhaps 95% to 80% returned to service with the 5% to 20% makeup coming from the polisher tank, and the polisher tank changed out (or sent to the main tank as-is) along with new adsorbent to the polisher during the cycle.

The top level of the adsorbent will contain the highest level of contaminant upon exhaustion of the bed. This top level, e.g., 5% to 20% is removed for downstream processing, described later. The bottom 95% to 80% is sent separately for regeneration. Then new adsorbent is added to the bottom of the tank (from a new source of the polisher tank) and regenerated adsorbent is returned to the top section of the tank. The bed is then returned for service for another 6 months.

The removed adsorbent is either sent off-site for regeneration or preferably regenerated on-site. The regeneration method (the preferred method for IE resin may be chemical regen) may use supercritical CO₂ as described herein mixed with water and operated at a temperature and pressure such that the water becomes steam. Adding water to the sCO₂ regenerant may increase adsorbent removal due to water dealing better with charged adsorbents such as some PFAS compounds, whereas CO₂ will do better with uncharged such as other PFAS compounds. Adding the water also makes things easier for the destruct process to operate (for chemical regen of IE, the water in the regenerant acts to provide the same amount of water). Once the adsorbent is regenerated, regardless of the percent regeneration, it can be returned to service. sCO₂ (and typical acid/base brine chemical regenerants for IE resin) are safe and so there should be no issue with return of the regenerated adsorbent to service even in drinking water applications.

The emerging contaminants that come off in the regeneration process and also the contaminant that is in the e.g. 5% to 20% of the adsorbent that has been removed from service may be destroyed. This can ideally be done on site but could also be done off-site. For sCO₂ regen the condensed water that is separated from gaseous CO₂ during the SCCO₂/steam process when the pressure of the system is removed as part of the cycle, and the condensed water will contain in solution nearly all the contaminant that was removed from the adsorbent that is regenerated. This, along with the removed solid adsorbent from the original removal step may be sent to a super critical water system which mineralizes both the contaminant and the solid adsorbent (other methods are possible but may be less effective). The carbon or resin removed from the top of the exhausted bed from the carbon/resin original contaminant removal steps above, provides the necessary heat source to maintain the SCWO temperatures without additional fuel required. Any residual contaminant not destroyed in a vapor phase or liquid phase off the SCWO system can be picked up using an ancillary vapor and/or liquid adsorbent column, e.g., carbon and/or IE resin, such that any gaseous or liquid effluent byproduct is ensured having no contaminant released to the environment. The advantage of this polisher is that not all the contaminant needs to be mineralized, since the polisher adsorbent can be recycled back to the regeneration process and/or back to the destruction process. SCWO is only an example because this process can use other destruction technologies and other percent destructions to be completely effective at zero contaminant discharge and 100% removal. A large advantage of this process is the entire bed need not be destroyed or treated once the bed is at the end of time for complete removal. For example, only the top 5% to 20% of the adsorbent bed needs to be treated in the destruct unit at any given cycle. This reduction in quantity of adsorbent and the low amount of water effluent containing concentrated contaminant dissolved makes it much easier and requires much smaller equipment to conduct the destruct process and therefore makes this process not only more cost effective, but much more amenable to on-site treatment.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A method of treating water containing a per-and/or poly-fluoroalkyl substance (PFAS), comprising:
introducing water containing PFAS to adsorption media to promote loading of the adsorption media with PFAS;
introducing supercritical carbon dioxide (sCO₂) to adsorption media loaded with PFAS to extract PFAS from the loaded adsorption media thereby forming an extractant mixture containing PFAS and treated adsorption media depleted of PFAS;
separating the extractant mixture containing PFAS from the treated adsorption media depleted of PFAS; and
separating PFAS from the extractant mixture.

2. The method of claim 1, wherein the PFAS comprises perfluorooctane sulfonic acid (PFOS), perfluorooctanoic acid (PFOA), or a perfluoroalkyl ether carboxylic acid.

3. The method of claim 1, wherein the adsorption media comprises granulated activated carbon (GAC) or ion exchange resin.

4. The method of claim 1, further comprising performing multiple extractions on a single batch of loaded adsorption media.

5. The method of claim 1, wherein liquid or gas carbon dioxide (CO₂) is introduced to the adsorption media loaded with PFAS, and further comprising promoting conversion of the CO₂ to the sCO₂.

6. The method of claim 5, wherein promoting conversion of the liquid or gas CO₂ to the sCO₂ comprises adjusting pressure and/or temperature conditions.

7. The method of claim 1, wherein separating the extractant mixture containing PFAS from the treated adsorption media comprises depressurizing the extractant mixture to promote flow of sCO₂ containing PFAS away from the treated adsorption media.

8. The method of claim 1, wherein separating PFAS from the extractant mixture comprises separating PFAS from gaseous CO₂.

9. The method of claim 8, further comprising reusing the gaseous CO₂ or storing the gaseous CO₂ for reuse.

10. The method of claim 1, further comprising destroying the separated PFAS.

11. The method of claim 10, wherein the PFAS is destroyed via supercritical water oxidation (SCWO) treatment.

12. The method of claim 10, wherein the PFAS is destroyed via incineration, plasma, electrooxidation or UV reduction treatment.

13. The method of claim 10, further comprising destroying at least a portion of the loaded adsorption media or the treated adsorption media.

14. The method of claim 13, wherein the destroyed adsorption media originates from about 5% to about 20% of an upper level of an associated adsorption column.

15. The method of claim 13, wherein the PFAS and/or adsorption media is destroyed onsite relative to the extraction step.

16. The method of claim 1, further comprising reactivating or regenerating the treated adsorption media.

17. The method of claim 16, further comprising reusing the reactivated or regenerated adsorption media for water treatment.

18. The method of claim 17, wherein new adsorption media is added to a bottom of an adsorption column and the reactivated or regenerated adsorption media is used to fill a remainder of the adsorption column.

19. The method of claim 18, wherein about 10% of the adsorption column is filled with new adsorption media and the balance is filled with the reactivated or regenerated adsorption media.

20. The method of claim 18, wherein no adsorption media is used for polishing downstream of the adsorption column.

21-50. (canceled)
